(19) United States
(12) Patent Application Publication
(10) Pub. No.: US 2010/0316161 A1
(43) Pub. Date: Dec. 16, 2010

(54) METHOD AND APPARATUS FOR TRANSMITTING/RECEIVING DATA USING SATELLITE CHANNEL

(75) Inventors: Pan-Soo KIM, Daejeon (KR); Dae-Ig Chang, Daejon (KR); Ho-Jin Lee, Daejon (KR); Stefano Cioni, Lugo (RA) (IT); Alessandro Vanelli-Coralli, Bologna (IT); Giovanni Emanuele Corazza, Bologna (IT)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/773,568

(22) Filed: May 4, 2010

(30) Foreign Application Priority Data
May 4, 2009 (KR) 10-2009-0039030

(51) Int. Cl. H04L 27/00; H04L 27/06

(52) U.S. Cl. 375/295; 375/316; 375/341; 375/344

(57) ABSTRACT

A method for transmitting data using a satellite channel includes: channel-encoding bit data using an e-BCH code; interleaving the encoded data; modulating the interleaved data according to a CPM scheme using four symbols; and transmitting the modulated data to a hub station.

### CROSS-REFERENCE(S) TO RELATED APPLICATIONS

The present application claims priority of Korean Patent Application No. 10-2009-0039030, filed on May 4, 2009, which is incorporated herein by reference in its entirety.

### BACKGROUND OF THE INVENTION

1. Field of the Invention

Exemplary embodiments of the present invention relate to a method and an apparatus for transmitting/receiving data using a satellite channel; and, more particularly, to a method and an apparatus for transmitting/receiving data in a satellite communication system including a hub station, a satellite transponder, and a user terminal.

2. Description of Related Art

Recently, broadcasting or communication services are provided using satellite links together with terrestrial networks. A satellite broadcasting service related to Digital Video Broadcasting (DVB)-Satellite(S) standards is being provided through C, Ku, and Ka bands, and satellite broadcasting services related with DVB-Technical Module (TM) and DVB-Satellite Second Generation (S2) standards are also available.

Meanwhile, since 2009, there has been extensive discussion on DVB-Return Channel via Satellite (RCS) Next Generation (NG), which is the next-generation Very Small Aperture Terminal (VSAT) system-related standard, in connection with European DVB. Most existing VSAT systems are used by large corporations in North America, Europe, Israel, etc. according to their own standards, but the DVB-RCS standard is recently discussed extensively particularly in Europe.

A satellite communication system basically includes a hub station (or gateway) configured to operate a communication service, a user terminal used by a service subscriber, and a satellite transponder. Data is transmitted from the hub station to the user terminal through a forward link, and data is transmitted from the user terminal to the hub station through a return link. As such, the satellite acts as a relay between the user terminal and the hub station.

The satellite communication system, due to the satellite transponder in the orbit, can provide a large area of service coverage. The satellite communication system also employs a high frequency band, i.e. Ku/Ka band, to provide a broadband communication service, increasing the available bandwidth.

However, the conventional satellite communication system has a problem in that the distance between the earth station (e.g. hub station, user terminal, etc.) and the satellite transponder may cause transmission delay and signal power attenuation, besides the cost for launching the satellite transponder in the orbit. Furthermore, use of the Ku/Ka band for satellite communication requires additional costs for analog devices for up-conversion from the baseband to the Ku/Ka band.

The cost problem may make it difficult for the communication service operator to enroll a large number of service subscribers, and development of devices for solving the problem of transmission delay and signal power attenuation may further increase the price of analog devices.

### SUMMARY OF THE INVENTION

An embodiment of the present invention is directed to a method and an apparatus for transmitting/receiving data using a satellite channel, which shows better data transmitting/receiving performance in an interference communication environment.

Another embodiment of the present invention is directed to a method and an apparatus for transmitting/receiving data using a satellite channel, which make it possible to economically manufacture or operate a device used in a satellite communication system.

Another embodiment of the present invention is directed to a method and an apparatus for transmitting/receiving data using a satellite channel, which have an improved data transmission rate in a satellite communication system based on DVB-S2 standards.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for transmitting data using a satellite channel includes: channel-encoding bit data using an e-BCH code; interleaving the encoded data; modulating the interleaved data according to a CPM scheme using four symbols; and transmitting the modulated data to a hub station.

In accordance with another embodiment of the present invention, a method for receiving data using a satellite channel includes: demodulating data transmitted from a user terminal according to a CPM scheme using four symbols; deinterleaving the demodulated data; and decoding the deinterleaved data using an e-BCH code.

In accordance with another embodiment of the present invention, a method for transmitting data using a satellite channel includes: modulating encoded and interleaved bit data; channel-encoding the modulated bit data using a space-time code; and transmitting the encoded data to a hub station using a polarization vertical antenna and a polarization horizontal antenna.

In accordance with another embodiment of the present invention, a method for receiving data using a satellite channel includes: receiving data transmitted from a user terminal using a polarization vertical antenna and a polarization horizontal antenna; decoding the received data using a space-time code; and demodulating the decoded data.

In accordance with another embodiment of the present invention, a user terminal using a satellite channel includes: an encoder configured to channel-encode bit data using an e-BCH code; an interleaver configured to interleave the encoded data; a modulator configured to modulate the interleaved data according to a CPM scheme using four symbols; and a transmitter configured to transmit the modulated data to a hub station.

In accordance with another embodiment of the present invention, a hub station using a satellite channel includes: a demodulator configured to demodulate data transmitted from a user terminal according to a CPM scheme using four symbols; a deinterleaver configured to deinterleave the demodulated data; and a decoder configured to decode the deinterleaved data using an e-BCH code.

In accordance with another embodiment of the present invention, a user terminal using a satellite channel includes: a modulator configured to modulate encoded and interleaved bit data; an encoder configured to channel-encode the modulated bit data using a space-time code; and a transmitter configured to transmit the encoded data to a hub station using a polarization vertical antenna and a polarization horizontal antenna.

In accordance with another embodiment of the present invention, a hub station using a satellite channel includes: a receiver configured to receive data transmitted from a user terminal using vertical and horizontal antennas; a decoder configured to decode the received data using a space-time code; and a demodulator configured to demodulate the decoded data.

### BRIEF DESCRIPTION OF THE DRAWINGS

FIG. 1 illustrates a method for transmitting data in accordance with an embodiment of the present invention.

FIG. 2 illustrates a burst frame in accordance with an embodiment of the present invention.

FIG. 3 illustrates a method for receiving data in accordance with an embodiment of the present invention.

FIG. 4 illustrates a satellite communication system 400 in accordance with an embodiment of the present invention.

FIGS. 5 and 6 show general AM-AM characteristics and AM-PM characteristics of a SSPA 413, respectively.

FIG. 7 shows PER performance through an AWGN channel when ATM-SAC packet size is 456 bits and spectral efficiency is 0.75 bit/s/Hz.

FIG. 8 shows PER performance through an AWGN channel when 1 MPEG packet size is 1504 bits and spectral efficiency is 0.75 bit/s/Hz.

FIGS. 9 and 10 show PER performance and necessary Es/N0 of a satellite communication system 400 based on spectral efficiency described in Table 3.

FIG. 11 shows a comparison between PER performance of a satellite communication system 400 in accordance with the present invention and PER performance based on a conventional DVB-RCS-based scheme.

FIGS. 12 and 13 show comparisons of PER performance of a satellite communication system 400 in accordance with the present invention in different communication environments.

FIG. 14 illustrates a method for transmitting/receiving data using a satellite in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Conventional VSAT systems, when CPM-type modulation is used, usually employ the Gaussian Minimum Shift Keying (GMSK) modulation scheme. However, the GMSK modulation scheme has low spectral efficiency, and makes it difficult to transmit a large amount of data.

The present invention provides a novel method for transmitting/receiving data, which has better transmission performance in an inferior communication environment, and which is applicable to a VSAT system. A method for transmitting/receiving data in accordance with the present invention, through a return link of a VSAT system, performs channel-encoding using an extended BCH (e-BCH) code, performs interleaving, and transmits the data using a Continuous Phase Modulation (CPM) scheme using four symbols. The CPM-modulated data is received, and error correction and restoration are performed. That is, in accordance with the present invention, a user terminal in a VSAT system transmits data through e-BCH encoding, interleaving, and CPM modulation, and a hub station in accordance with the present invention receives the data from the user terminal and restores data.

In accordance with the present invention, the transmission performance is better in an inferior environment for an analog device compared with conventional DVB-RCS standards. The present invention also transmits data through predetermined interleaving, so that data can be transmitted with no limitation on packet length.

Another method for transmitting/receiving data in accordance with the present invention, through a return link of a DVB-S2 satellite broadcasting system, performs channel encoding according to a space-time code based on a MIMO system and then transmits data. The method for transmitting data in accordance with the present invention may perform channel encoding using a golden code as the space-time code. The method for receiving data in accordance with the present invention receives data, which has been channel-encoded according to the space-time code, and performs error correction and restoration. That is, a user terminal in accordance with the present invention performs channel encoding according to a space-time code and transmits data, and a hub station in accordance with the present invention receives the data, which has been channel-encoded according to the space-time code, and performs error correction and restoration.

In accordance with the present invention, use of vertical and horizontal polarization makes frequency reuse possible and thus improves transmission efficiency.

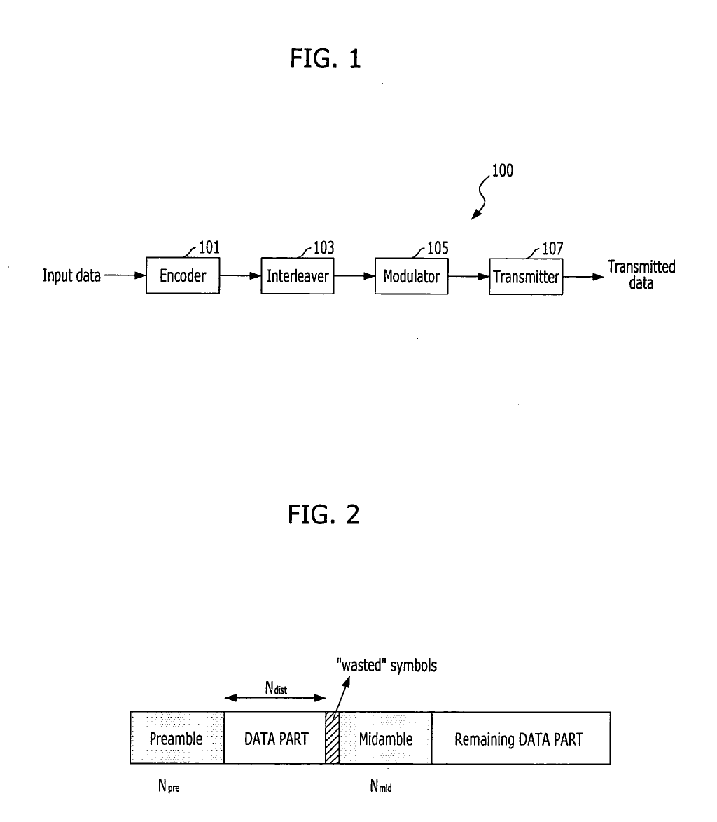

FIG. 1 illustrates a method for transmitting data in accordance with an embodiment of the present invention. Specifically, FIG. 1 illustrates a method for transmitting data by a user terminal 100 through a return link in a satellite communication system in accordance with an embodiment of the present invention.

Referring to FIG. 1, the user terminal 100 in accordance with the present invention includes an encoder 101, an interleaver 103, a modulator 105, and a transmitter 107.

The encoder 101 is configured to receive bit data and perform channel encoding using an e-BCH code. The interleaver 103 is configured to interleave the data encoded by the encoder 101. The modulator 105 is configured to modulate the interleaved data through a CPM scheme using four symbols. The transmitter 107 is configured to transmit the modulated data to a hub station.

Each of the encoder 101, the interleaver 103, the modulator 105, and the transmitter 107 of the user terminal 100 will now be described in more detail.

The encoder 101 is configured to perform channel encoding by means of an e-BCH block code. The embodiment illustrated in FIG. 1 is described in connection with channel encoding based on a linear systematic code having k=51, n=64, and dₘᵢₙ=6, wherein k refers to the length (bit unit) of information data among input bit data, n refers to the length (bit unit) of a codeword, and dₘᵢₙ refers to the minimum distance, specifically Hamming distance. In this case, the code rate in the encoder 101 is 51/64.

The encoder 101 is configured to generate a matrix G defined by Equation 1 below, wherein I refers to an identify matrix, and P refers to a parity check matrix. The matrix G generated by I and P is a k by n matrix. The parity check matrix is given in Table 1 below. The matrix G generated by the encoder 101 (Generating Matrix) is used to generate a codeword.

G_{k×n}^{e-BCH}=[I_{k×k}|P_{k×(n-k)}] Eq. 1

TABLE 1

| | | | | | | | | | | | | |
|---|---|---|---|---|---|---|---|---|---|---|---|---|
| 1 | 0 | 0 | 1 | 1 | 1 | 0 | 0 | 1 | 0 | 1 | 0 | 1 |
| 0 | 1 | 0 | 0 | 1 | 1 | 1 | 0 | 0 | 1 | 0 | 1 | 1 |
| 1 | 0 | 1 | 1 | 1 | 0 | 1 | 1 | 1 | 0 | 0 | 0 | 0 |
| 0 | 1 | 0 | 1 | 1 | 1 | 0 | 1 | 1 | 1 | 0 | 0 | 0 |
| 0 | 0 | 1 | 0 | 1 | 1 | 1 | 0 | 1 | 1 | 1 | 0 | 0 |
| 0 | 0 | 0 | 1 | 0 | 1 | 1 | 1 | 0 | 1 | 1 | 1 | 0 |
| 1 | 0 | 0 | 1 | 0 | 1 | 1 | 1 | 0 | 0 | 0 | 1 | 1 |
| 1 | 1 | 0 | 1 | 0 | 1 | 1 | 1 | 0 | 0 | 1 | 0 | 0 |
| 0 | 1 | 1 | 0 | 1 | 0 | 1 | 1 | 1 | 0 | 0 | 1 | 0 |
| 1 | 0 | 1 | 0 | 1 | 0 | 0 | 1 | 0 | 1 | 1 | 0 | 1 |
| 0 | 1 | 0 | 1 | 0 | 1 | 0 | 0 | 1 | 0 | 1 | 1 | 1 |
| 1 | 0 | 1 | 1 | 0 | 1 | 1 | 0 | 1 | 1 | 1 | 1 | 0 |
| 1 | 1 | 0 | 0 | 0 | 1 | 1 | 1 | 1 | 1 | 0 | 1 | 1 |
| 1 | 1 | 1 | 1 | 1 | 1 | 1 | 1 | 0 | 1 | 0 | 0 | 0 |
| 0 | 1 | 1 | 1 | 1 | 1 | 1 | 1 | 1 | 0 | 1 | 0 | 0 |
| 0 | 0 | 1 | 1 | 1 | 1 | 1 | 1 | 1 | 1 | 0 | 1 | 0 |
| 1 | 0 | 0 | 0 | 0 | 0 | 1 | 1 | 0 | 1 | 0 | 0 | 1 |
| 0 | 1 | 0 | 0 | 0 | 0 | 0 | 1 | 1 | 0 | 1 | 0 | 1 |
| 0 | 0 | 1 | 0 | 0 | 0 | 0 | 0 | 1 | 1 | 0 | 1 | 1 |
| 1 | 0 | 0 | 0 | 1 | 1 | 0 | 0 | 1 | 1 | 0 | 0 | 0 |
| 0 | 1 | 0 | 0 | 0 | 1 | 1 | 0 | 0 | 1 | 1 | 0 | 0 |
| 0 | 0 | 1 | 0 | 0 | 0 | 1 | 1 | 0 | 0 | 1 | 1 | 0 |
| 1 | 0 | 0 | 0 | 1 | 1 | 0 | 1 | 0 | 0 | 1 | 1 | 1 |
| 1 | 1 | 0 | 1 | 1 | 0 | 1 | 0 | 0 | 0 | 1 | 1 | 0 |
| 1 | 1 | 1 | 1 | 0 | 0 | 0 | 1 | 1 | 0 | 1 | 1 | 1 |
| 1 | 1 | 1 | 0 | 0 | 1 | 0 | 0 | 0 | 1 | 1 | 1 | 0 |
| 1 | 1 | 1 | 0 | 1 | 1 | 1 | 0 | 1 | 0 | 0 | 1 | 1 |
| 1 | 1 | 1 | 0 | 1 | 0 | 1 | 1 | 1 | 1 | 1 | 0 | 0 |
| 0 | 1 | 1 | 1 | 0 | 1 | 0 | 1 | 1 | 1 | 1 | 1 | 0 |
| 1 | 0 | 1 | 0 | 0 | 1 | 1 | 0 | 0 | 1 | 0 | 1 | 1 |
| 1 | 1 | 0 | 0 | 1 | 1 | 1 | 1 | 1 | 0 | 0 | 0 | 0 |
| 0 | 1 | 1 | 0 | 0 | 1 | 1 | 1 | 1 | 1 | 0 | 0 | 0 |
| 0 | 0 | 1 | 1 | 0 | 0 | 1 | 1 | 1 | 1 | 1 | 0 | 0 |
| 0 | 0 | 0 | 1 | 1 | 0 | 0 | 1 | 1 | 1 | 1 | 1 | 0 |
| 1 | 0 | 0 | 1 | 0 | 0 | 0 | 0 | 0 | 1 | 0 | 1 | 1 |
| 1 | 1 | 0 | 1 | 0 | 1 | 0 | 0 | 1 | 0 | 0 | 0 | 0 |
| 0 | 1 | 1 | 0 | 1 | 0 | 1 | 0 | 0 | 1 | 0 | 0 | 0 |
| 0 | 0 | 1 | 1 | 0 | 1 | 0 | 1 | 0 | 0 | 1 | 0 | 0 |
| 0 | 0 | 0 | 1 | 1 | 0 | 1 | 0 | 1 | 0 | 0 | 1 | 0 |
| 1 | 0 | 0 | 1 | 0 | 0 | 0 | 1 | 1 | 1 | 1 | 0 | 1 |
| 0 | 1 | 0 | 0 | 1 | 0 | 0 | 0 | 1 | 1 | 1 | 1 | 1 |
| 1 | 0 | 1 | 1 | 1 | 0 | 0 | 0 | 1 | 1 | 0 | 1 | 0 |
| 1 | 1 | 0 | 0 | 0 | 0 | 0 | 0 | 1 | 1 | 0 | 0 | 1 |
| 0 | 1 | 1 | 0 | 0 | 0 | 0 | 0 | 0 | 1 | 1 | 0 | 1 |
| 0 | 0 | 1 | 1 | 0 | 0 | 0 | 0 | 0 | 0 | 1 | 1 | 1 |
| 1 | 0 | 0 | 0 | 0 | 1 | 0 | 0 | 1 | 0 | 1 | 1 | 0 |
| 1 | 1 | 0 | 1 | 1 | 1 | 1 | 0 | 1 | 1 | 1 | 1 | 1 |
| 1 | 1 | 1 | 1 | 0 | 0 | 1 | 1 | 1 | 1 | 0 | 1 | 0 |
| 1 | 1 | 1 | 0 | 0 | 1 | 0 | 1 | 0 | 1 | 0 | 0 | 1 |
| 0 | 1 | 1 | 1 | 0 | 0 | 1 | 0 | 1 | 0 | 1 | 0 | 1 |
| 0 | 0 | 1 | 1 | 1 | 0 | 0 | 1 | 0 | 1 | 0 | 1 | 1 |

The encoder 101 is configured to divide the input data length K bits by N_{b} of k_{shortened} bits in order to have the target code rate R_{target} and the same error correction ability for each block, as defined by Equation 2 below. That is, the encoder 101 splits the input data to encode it into a code having k=51 and n=64. Therefore, the target code rate R_{target} becomes smaller than the code rate (k/n) of e-BCH. The target code rate R_{target} may be set by the operator of the satellite communication system.

$${N}_{b} = ⌊ \frac{K}{n - k} \cdot ( \frac{1}{{R}_{target}} - 1 ) ⌋ \\ {k}_{shortened} = ⌊ \frac{K}{{N}_{b}} ⌋ \\ {q}_{1} = K - ( {N}_{b} \cdot {k}_{shortened} ) \\ {q}_{2} = {N}_{b} - {q}_{1} \\ {R}_{effective} = \frac{K}{K + {N}_{b} \cdot ( n - k )} = \frac{K}{N} \qquad Eq . 2$$

In Equation 2, ┐ ┘ indicates a floor operator, which discards the remainder. The input data length K bit is divided by N_{b} block. The length of q₁ is k_{shortened}+1, and the length of q₂ is k_{shortened}. The R_{effective} code rate according to Equation 2 may be slightly different from the target code rate R_{target}.

In each block divided by N_{b}, zeros are inserted in front of the packet by the encoder 101 having k bits (u=┐0 . . . 0,b₁b₂ . . . bₖ_{_{shortened}}┘). The encoder 101 is configured to generate the final codeword c defined by Equation 3 below using the generating matrix G according to Equation 1 and the block divided by N_{b}, into which zeros have been inserted.

c_{1×n}=u_{1×k}·G_{k×n}^{e-BCH} Eq. 3

The interleaver 103 is configured to interleave data encoded by the encoder 101. The interleaver 103 may perform interleaving according to a S-random interleaving (or spread interleaving) scheme defined by Equation 4 below, in order to change burst error, which exists in encoded data, into random error. The S-random interleaving, which is aimed at improving problems of random interleaving, causes a number of consecutive pieces of data to be spaced at least a predetermined distance.

In Equation 4, N refers to the block length divided by N_{b}, and P₁ and P₂ are 1103 and 251, respectively.

j=(i×P₁+P₂)mod/N i=0,1,2, . . . , N−1 Eq. 4

The modulator 105 is configured to modulate data, which has been interleaved by the interleaver 103, through a CPM scheme exhibiting phase continuity characteristics. Specifically, the modulator 105 is configured to modulate interleaved data through a CPM scheme using four symbols.

A method of modulation according to the CMP scheme is defined by Equation 5 below, wherein E refers to symbol energy, T refers to symbol time, f₀ refers to carrier frequency, and φ₀ refers to arbitrary fixed phase shift. The φ₀ may be set to zero for synchronous demodulation.

$$s ( t , α ) = \sqrt{\frac{2 E}{T}} cos [ 2 π {f}_{0} t + ϕ ( t , α ) + {ϕ}_{0} ] \qquad Eq . 5$$

In general, data information is loaded onto the phase value of φ(t,α), which is defined by Equation 6 below, wherein αₖ refers to an uncorrelated information data symbol sequence having similar probability of occurrence, the value of which is one of {±1, ±3, ±(M−1)}, and M refers to constellation cardinality.

In accordance with an embodiment of the present invention, M=4, and as described above, the modulator 105 performs modulation in a CPM scheme using four symbols. The CPM scheme having M=4 will hereinafter be referred to as a quaternary CPM scheme. When M=4, αₖ can be gray-mapped onto four symbols as shown in Table 2 below. In Equation 6 below, h refers to modulation index.

$$ϕ ( t , α ) = 2 π h {\int }_{- ∞}^{t} {\sum }_{k = - ∞}^{+ ∞} {α}_{k} g ( τ - kT ) d τ \qquad Eq . 6$$

TABLE 2

| Bits | Symbol |
|---|---|
| 00 | −3 |
| 01 | −1 |
| 11 | 1 |
| 10 | 3 |

A general CPM scheme will now be described. Modulation according to a CPM scheme requires that the frequency pulse g(t) in Equation 6 satisfy the condition defined by Equation 7 below, wherein L refers to the CPM memory length, and T refers to symbol interval.

$$\{ \begin{matrix}g ( t ) = 0 , & t \leq 0 or t \geq LT \\ g ( t ) \neq 0 , & 0 < t < LT\end{matrix} \qquad Eq . 7$$

A phase response to a baseband is defined by Equation 8 below, and function q(t) in Equation 8 must satisfy the condition defined by Equation 9 below.

$$\begin{matrix}q ( t ) = {\int }_{- ∞}^{t} g ( τ ) d τ & Eq . 8 \\ q ( t ) = \{ \begin{matrix}0 , & t \leq 0 \\ \frac{1}{2} , & t \geq LT\end{matrix} & Eq . 9\end{matrix}$$

Using Equations 7 to 9, Equation 6 can be expressed without integration operation, as defined by Equation 10 below.

$$ϕ ( t , α ) = 2 π h {\sum }_{k = - ∞}^{+ ∞} {α}_{k} q ( τ - kT ) \qquad Eq . 10$$

Meanwhile, phase impulse shape g(t) according to the quaternary CPM scheme can be expressed in terms of a Raised-Cosine (RC) function as defined by Equation 11. Using Equation 12, Equation 10 can be rewritten into Equation 13.

$$\begin{matrix} g ( t ) = \{ \begin{matrix}\frac{1}{2 LT} [ 1 - cos ( \frac{2 π t}{LT} ) ] , & 0 \leq t \leq LT \\ 0 , & elsewhere\end{matrix} & Eq . 11 \\ g ( t ) = \frac{t}{2 LT} - \frac{1}{4 π} sin ( \frac{2 π t}{LT} ) 0 \leq t \leq LT & Eq . 12 \\ ϕ ( t , {α}_{n} ) = π h {\sum }_{k = 0}^{n - L} {α}_{k} + 2 π h {\sum }_{k = n - L + 1}^{n} {α}_{k} q ( t - kT ) = {θ}_{n} + θ ( t , {α}_{n} ) & Eq . 13\end{matrix}$$

In Equation 13, θₙ refers to a phase state at time n−L, θ(t,αₙ) refers to a partial response from time n−L to time n, and L>1 in this case. In other words, a partial response signal φ(t,αₙ) in an arbitrary symbol interval n is defined by the current data symbol αₙ, and, at symbol n−L, defined as a correlative state vector (αₙ₋₁, αₙ₋₂, . . . , αₙ₋₊₁) and phase state θₙ. When L=1, the correlative state vector becomes an empty vector.

Assuming that h refers to a ratio between prime numbers, i.e. the modulation index is expressed as a ratio to a prime number, h=m/p, and every possible phase state value, θₙ, can be expressed by Equation 14 below.

$${θ}_{S} = \{ 0 , \frac{π m}{p} , \frac{2 π m}{p} , … , \frac{( p - 1 ) π m}{p} \} ( \begin{matrix}even m , p -> \\ phase state value\end{matrix} ) \\ {θ}_{S} = \{ 0 , \frac{π m}{p} , \frac{2 π m}{p} , … , \frac{( 2 p - 1 ) π m}{p} \} ( \begin{matrix}odd m , 2 p -> \\ phase state value\end{matrix} ) \qquad Eq . 14$$

CPM modulation can be expressed as a time-variant trellis having a modulation state defined by vector δₙ=(θₙ, αₙ₋₁, αₙ₋₂, α_{n-L+1}). The correlative state is influenced by the last n−L+1 data symbol, and the phase state transition is calculated by Equation 15 below.

θₙ₊₁=θₙ+πhα_{n-L+1} Eq. 15

Due to memory limitation, detection of a CPM signal requires a decoder-based trellis. The CPM state number, Nₛ, is calculated by Equation 16 below.

$${N}_{S} = \{ \begin{matrix}{pM}^{L - 1} , & for even m \\ 2 {pM}^{L - 1} , & for odd m\end{matrix} \qquad Eq . 16$$

The transmitter 107 is configured to transmit modulated data to the hub station. Specifically, the transmitter 107 may generate a burst frame illustrated in FIG. 2 and transmit the generated burst frame to the hub station.

A burst frame transmitted through a return link in a conventional DVB-RCS system has a structure including a preamble Nₚᵣₑ (0<Nₚᵣₑ<256) and information data, but a burst frame in accordance with the present invention includes, as illustrated in FIG. 2, a preamble Nₚᵣₑ, information data N_{dist}, wasted symbols, a midamble N_{mid}, and remaining data. The information data and remaining data may vary depending on the size of input data.

The wasted symbols are inserted between the preamble and the midamble so that the receiving side can change the modulation state into a predetermined known state. More specifically, when a CPM signal is transmitted, the receiving side, even when knowing the i^{th} transmitted symbol, needs to know the CPM signal in time interval [iT; kT+T]. Considering this, the user terminal 100 transmits wasted symbols to the receiving side (hub station) so that the receiving side can change the modulation state into a predetermined known state. For example, the wasted symbols have continuous values, and the hub station can change the modulation state into a predetermined known state using such wasted symbols.

The amount of wasted symbols, also referred to as a state-forcing sequence, depends on the CPM format regardless of whether useful information is transmitted or symbols for channel estimation are transmitted. The length of wasted symbols is determined by L−1+┌p/M┐, wherein ┌x┐ refers to an integer smaller than x.

Meanwhile, since the band of CPM has an infinite value, an effective frequency band capable of isolating an adjacent channel user is important. In addition, selection of a power ratio for defining the effective frequency band is also important. In accordance with an embodiment of the present invention, the power ratio for defining the effective frequency band is 99%, and the relationship between spectral efficiency, target code rate R_{target}, CPM scheme, and effective frequency band (BW99%) is given in Table 3 below, wherein 1/T refers to a symbol rate, and the effective frequency bandwidth is normalized to T.

TABLE 3

| Spectral | | | BW99% |
|---|---|---|---|
| Efficiency | e-BCH R_{target} | CPM Scheme | [normalized to T] |
| 0.75 bit/s/Hz | 0.7053 | Q2RC, h = 3/7 | 1.8773 |
| 1.00 bit/s/Hz | 0.7162 | Q2RC, h = 2/7 | 1.3772 |
| 1.25 bit/s/Hz | 0.7048 | Q3RC, h = 2/7 | 1.1193 |
| 1.50 bit/s/Hz | 0.7689 | Q3RC, h = 1/4 | 1.0151 |

The above-described method for transmitting data in accordance with the present invention is summarized as follows.

The user terminal 100 channel-encodes bit data using an e-BCH code, and interleaves the encoded data. The user terminal 100 modulates the interleaved data according to a CPM scheme using four symbols, and transmits the modulated data to the hub station.

The user terminal 100 may perform S-random interleaving. The user terminal 100 may generate a burst frame using the modulated data, and transmit the generated burst frame to the hub station. The burst frame includes a preamble interval, a first data interval, a symbol interval for changing the modulation state of the receiving side into a predetermined state, a midamble interval, and a second data interval successively. Bit data inputted to the encoder 101 includes first data and second data.

As such, the method for transmitting data in accordance with the present invention can improve transmission performance through a return link of a VSAT system by using a conventional e-BCH code and a CPM scheme.

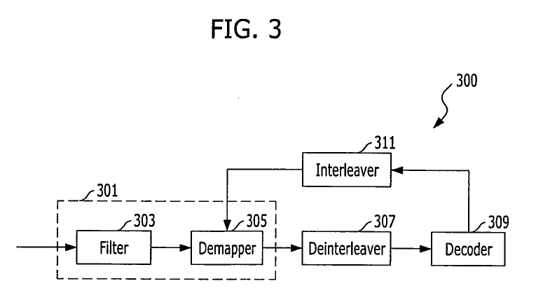

FIG. 3 illustrates a method for receiving data in accordance with an embodiment of the present invention. Specifically, FIG. 3 illustrates a method for receiving data by a hub station 300 through a return link of a satellite communication system in accordance with an embodiment of the present invention.

The hub station 300 in accordance with the present invention is configured to receive data transmitted from a user terminal 100. Referring to FIG. 3, the hub station 300 in accordance with the present invention includes a demodulator 301, a deinterleaver 307, and a decoder 309.

The demodulator 301 is configured to demodulate data transmitted from the user terminal 100, i.e. CPM-modulated signal. Specifically, the demodulator 301 is configured to convert symbols, which are based on CPM modulation using four symbols, into bit data. In this case, the four symbols are −3, −3, 1, and 3, which are demapped onto 00, 01, 11, and 10 bits, respectively. The demodulator 301 may include a filter 303 and a demapper 305.

The filter 303 serves to restore frequency error of data transmitted from the user terminal 100, and is configured to perform filtering to obtain symbol synchronization, frequency synchronization, and phase synchronization. The demapper 305 is configured to convert CPM modulation-based symbols into bit data using a synchronized signal.

The deinterleaver 307 is configured to deinterleave the signal demodulated by the demodulator 301. The deinterleaver 307 may perform Log-Likelihood Ratio (LLR) deinterleaving to perform soft decision regarding the demodulated signal.

The decoder 309 is configured to decode the signal deinterleaved by the deinterleaver 307 using an e-BCH code. The decoder 309 may decode a signal, which has been channel-encoded by an e-BCH code, using Chase-Pyndiah algorithm. As mentioned above, when a signal channel-encoded with k=51 and n=64 is decoded using Chase-Pyndiah algorithm, the complexity of encoder in terms of logic gate is comparable to or smaller than when 32-states Convolutional Code (CC) is used for encoding.

The hub station 300 can use the interleaver 311 to interleave again the signal from the decoder 309 so that decoding is repeated a predetermined number of times. Specifically, when decoding is to be repeated, the output signal of the decoder 309 is inputted to the interleaver 311, and the interleaved signal is again inputted to the demodulator 301. The predetermined number of times is set to a maximum of 30 times in accordance with an embodiment of the present invention.

The above-described method for receiving data in accordance with the present invention is summarized as follows.

The hub station 300 in accordance with the present invention demodulates data from the user terminal 100 according to a CPM scheme using four symbols, and deinterleaves the demodulated data. The hub station 300 decodes the deinterleaved data using an e-BCH code. The four symbols are −3, −1, 1, and 3, which are demapped onto 00, 01, 11, and 10 bits, respectively.

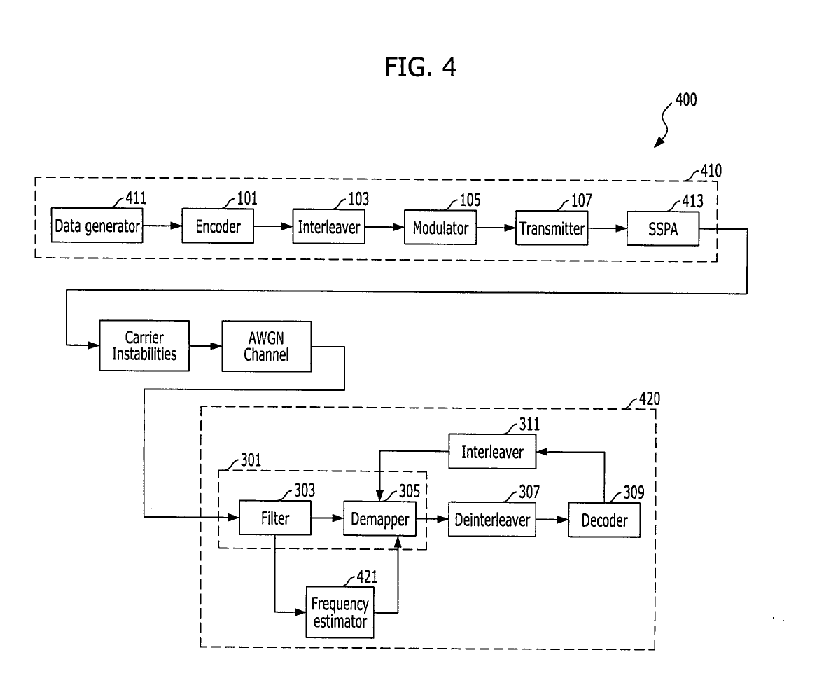

The hub station 300 may perform soft decision regarding the demodulated data through LLR deinterleaving and perform frequency estimation for removing frequency error of the data transmitted from the user terminal 100. The frequency estimation will be described later in more detail with reference to FIG. 4.

The hub station 300 may additionally interleave the decoded data so that decoding is repeated a predetermined number of times and demodulate the interleaved data according to a CPM scheme.

As such, the method for receiving data in accordance with the present invention receives a signal, which has been channel-encoded with an e-BCH code and modulated according to a quaternary CPM scheme, demodulates and decodes the signal.

FIG. 4 illustrates a satellite communication system 400 in accordance with an embodiment of the present invention. Specifically, FIG. 4 illustrates a case of transmission of a signal from a user terminal 410 through an Additive White Gaussian Noise (AWGN) channel in a carrier instability environment where frequency error, phase noise, and the like occur.

The user terminal 410 of FIG. 4 corresponds to the user terminal 100 of FIG. 1, except that the user terminal 410 further includes a data generator 411 and a Solid State Power Amplifier (SSPA) 413. The data generator 411 is configured to generate bit data inputted to the encoder 101. The SSPA 413 is configured to amplify a burst frame generated by the transmitter 107.

The hub station 420 of FIG. 4 corresponds to the hub station 300 of FIG. 3, except that the hub station 420 further includes a frequency estimator 421. The frequency estimator 421 is configured to correct frequency error occurring in the process of transmission of a signal from the user terminal 410. That is, the frequency estimator 421 performs frequency estimation for correcting frequency error using a signal filtered by the filter 303. The frequency estimator 421 is configured to estimate frequency through the following conventional frequency estimation process.

(1) Correlation Functions

The frequency estimator 421 obtains correlation defined by Equation 17 below using known data in the preamble and midamble of a received signal, i.e. signal transmitted from the user terminal 410. In Equation 17, ν refers to an unknown frequency mismatch value, θ(t) refers to a carrier phase-noise process value, and parameter D corresponds to a wasted symbol considered by N_{dist}.

$$\begin{matrix}{z}_{n}^{pre} = {\int }_{nT}^{nT + T} r ( t ) s * ( t , α ) d t & n = 0 , 1 , … {N}_{pre} - 1 \\ {z}_{n}^{mid} = {\int }_{( n + {N}_{pre} + D ) T}^{( n + {N}_{pre} + D ) T + T} r ( t ) s * ( t , α ) d t & n = 0 , 1 , … {N}_{mid} - 1\end{matrix} \qquad Eq . 17$$

(2) FFT Computation

The frequency estimator 421 performs Fast Fourier Transform (FFT), as defined by Equation 18 below, using the result of Equation 17. In Equation 18, ρ refers to a pruning factor of Rife and Boorstyn (R&B) algorithm. Zeros are inserted into a signal inputted to the frequency estimator 421, and the total length of symbols used for frequency estimation is ρ(Nₚᵣₑ+D+N_{mid}). The R&B algorithm is one of FFT algorithms for extracting spectral components.

$${Z}_{k}^{pre} = {\sum }_{n = 0}^{ρ ( {N}_{pre} + D + {N}_{mid} ) - 1} {z}_{n}^{pre} {e}^{- j 2 π \frac{kn}{ρ ( {N}_{pre} + D + {N}_{mid} )}} \\ {Z}_{k}^{mid} = {\sum }_{n = 0}^{ρ ( {N}_{pre} + D + {N}_{mid} ) - 1} {z}_{n}^{mid} {e}^{- j 2 π \frac{kn}{ρ ( {N}_{pre} + D + {N}_{mid} )}} \qquad Eq . 18$$

(3) Sequence Combination

The frequency estimator 421 combines the two frequency domain-related sequences, which result from Equation 18, as defined by Equation 19 below.

$${Z}_{k} = {Z}_{k}^{pre} + {Z}_{k}^{mid} {e}^{- j2π \frac{k ( {N}_{pre} + D )}{ρ ( {N}_{pre} + D + {N}_{mid} )}} k = 0 , 1 , … ( \begin{matrix}{N}_{pre} + \\ D + \\ {N}_{mid}\end{matrix} ) - 1 \qquad Eq . 19$$

(4) Search for the Maximum Value

The frequency estimator 421 obtains \hat{k}, which indicates maximum value |Zₖ|² using the result of Equation 19, and obtains a frequency mismatch value using Equation 20 below.

$$\hat{v} = \frac{\hat{k}}{ρ ( {N}_{pre} + D + {N}_{mid} )} T \qquad Eq . 20$$

Meanwhile, the complex envelope of the signal received by the hub station 420, i.e. CPM-modulated signal, may be expressed, for symbol detection, according to Equation 21 below, wherein F=(M−1)*2^{(L-1)logM}, which indicates the number of modulated pulses pₖ(t), and β_{k,n} refers to a pseudo-symbol. The pulse pₖ(t) and symbol p_{k,n}, are major parameters of the CPM function.

$$s ( t , α ) = {\sum }_{k = 0}^{F - 1} {\sum }_{n} {β}_{k , n} {p}_{k} ( t - nT ) \qquad Eq . 21$$

In order to reduce the complexity of the demodulator 301, the condition of S<F may be used for linear filtering by the filter 303, wherein S=(M−1)M^{L-1}, F=(M−1)*2^{(L-1})^{logM}. Among the first four symbols (M=4), a CPM modulation-based pulse corresponding to ‘−1’ is referred to as a principal component. If L<3, it is sufficient to gather energy necessary for transmission. If L≧3, the value of F and the length of linear filter become larger, making it necessary to increase the length of modulated pulses pₖ(t).

In general, CPM modulation is performed according to a Maximum-Likelihood Sequence Detection (MLSD) based on consideration of the intrinsic memory of CPM signals. However, the demapper 305 in accordance with an embodiment of the present invention applies BCJR algorithm and performs demodulation, assuming coherent demodulation, in order to remove carrier phase error. According to the BCJR algorithm, a probability value is expressed as/data through soft decision during data detection.

When phase noise is considered, phase synchronization technology by the demapper 305 may be combined with the BCJR algorithm through Bayesian technique. That is, the demapper 305 can additionally correct the frequency, which has been corrected incompletely by the frequency estimator 421.

In this case, actually implementable {2πi/R}ᵢ₌ₒ^{R-1} is obtained by dividing the channel phase estimation value in the phase value by a discrete value. In the formula, R refers to a value determining the scale of state of a phase value corresponding to 2 pi, and has a value of 6 p in accordance with an embodiment of the present invention, and p refers to denominator of CPM modulation index h.

Those skilled in the art can understand that, although no satellite is included in the satellite communication system 400 described with reference to FIG. 4, signals from a user terminal are transmitted to the hub station through a relay satellite in an actual satellite communication system.

Results of simulation of the satellite communication system 400 illustrated in FIG. 4 will now be described.

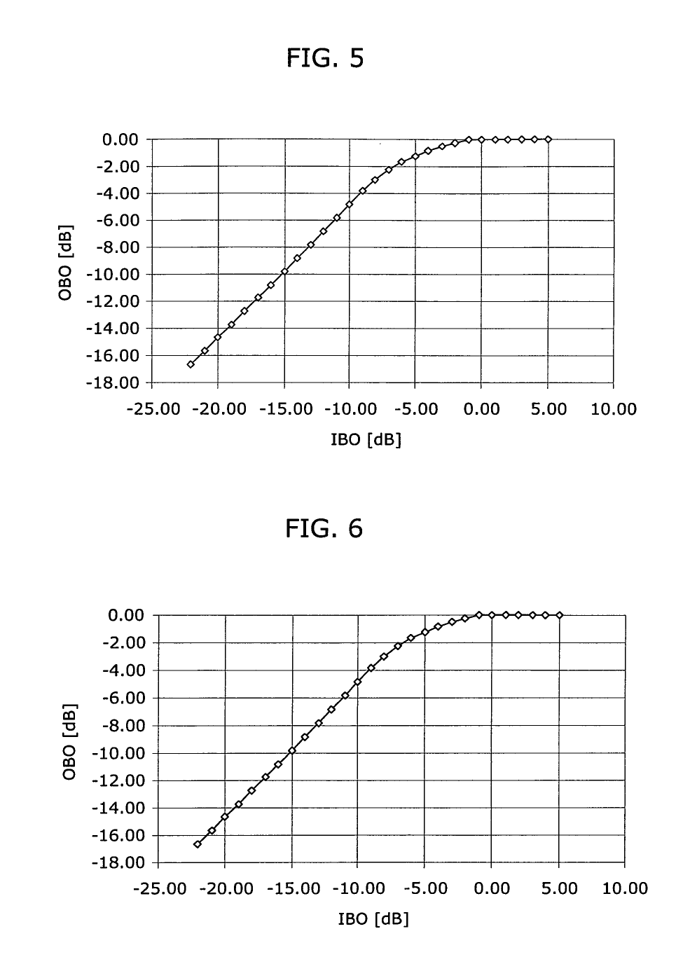

FIGS. 5 and 6 show general Amplitude Modulation (AM)-AM characteristics and AM-Phase Modulation (1M) characteristics of a SSPA 413, respectively. It is clear from FIGS. 5 and 6 that the relationship between Input Back-Off (IBO) and Output Back-Off (OBO) regarding the SSPA 413 exhibits linear characteristics in an interval and then nonlinear characteristics after the interval. It is assumed in the following description of simulation results that the OBO is 0.5 dB in the interval exhibiting nonlinear characteristics. The OBO is generally described in terms of dB with the minus sign omitted.

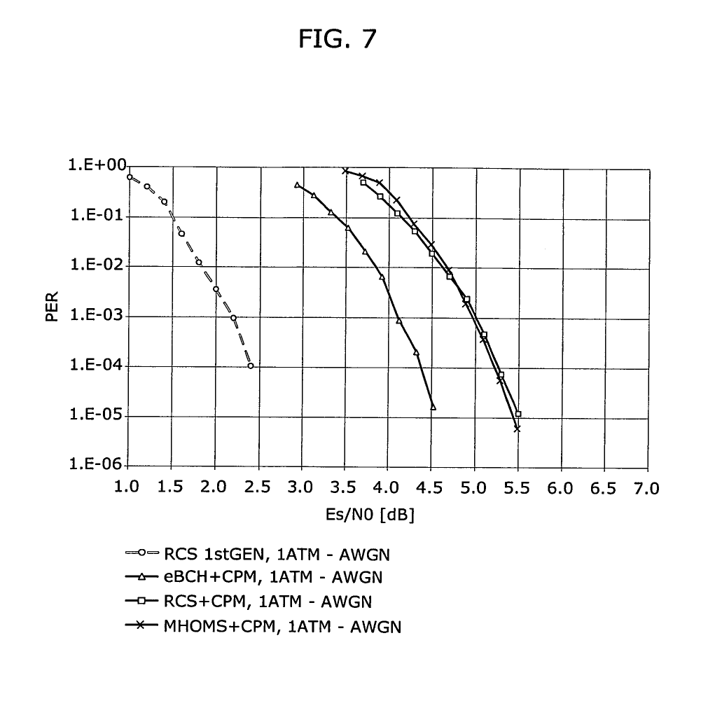

FIG. 7 shows Packet Error Rate (PER) performance through an AWGN channel when ATM-SAC packet size is 456 bits and spectral efficiency is 0.75 bit/s/Hz. FIG. 7 shows the PER performance based on the assumption that the satellite communication system 400 of FIG. 4 includes no SSPA and is not in a carrier instability environment. In this connection, it will be assumed in the following description of PER performance with reference to FIGS. 7 to 13 that ‘AWGN’ indicates no use of a SSPA and no carrier instability environment, and ‘FreqAcq+PhNoise’ indicates use of a SSPA and a carrier instability environment.

In FIG. 7, RCS 1st GEN indicates a result from QPSK+turbo code, eBCH+CPM indicates a result in accordance with the present invention, and both RCS+CPM and MHOMS+CPM indicate results from quaternary CPM+turbo code. It is to be noted that MHOMS+CPM indicates a result from a turbo code superior to that of RCS+CPM.

In FIG. 7, the lower the PER and Energy per Symbol per Noise Power Spectral Density (Es/N0) are, the better the performance is. It is clear from FIG. 7 that, when the satellite communication system 400 includes no analog device (SSPA) and is in no carrier instability environment, the conventional DVB-RCS-based scheme, i.e. RCS 1st GEN exhibits the best PER performance. Furthermore, combined use of a conventional turbo code with a CPM scheme deteriorates performance, and the result in accordance with the present invention has inferior performance than the conventional DVB-RCS-based scheme.

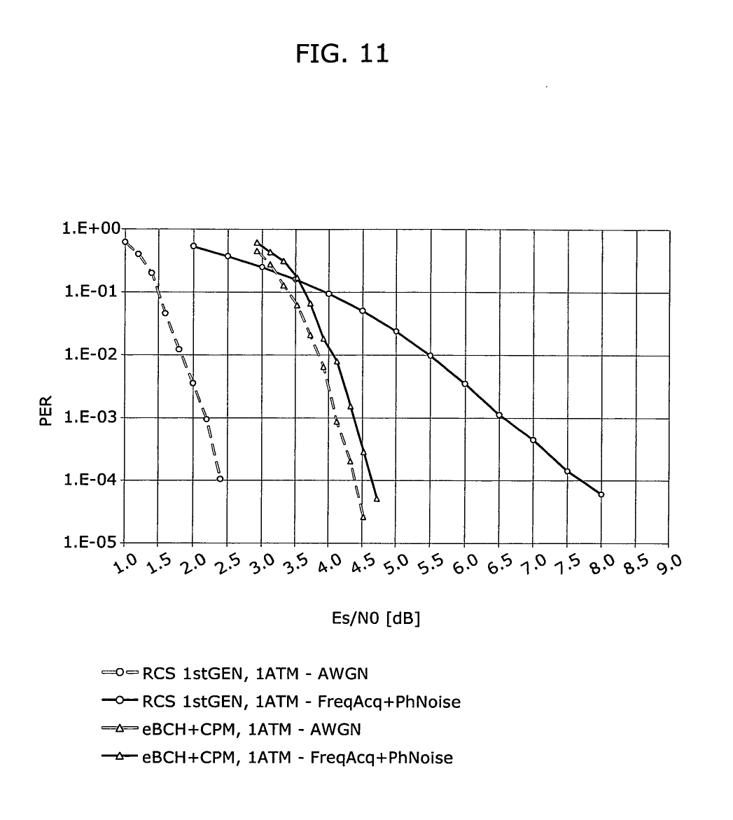

This means that, when the satellite communication system 400 includes no analog device (SSPA) and is in no carrier instability environment, the conventional DVB-RCS-based scheme exhibits the best PER performance. However, those skilled in the art can understand that a satellite communication system designed and used actually includes a SSPA, and frequency error, phase noise, and the like occur in the data transmission environment, which is then a carrier instability environment. Results of simulation of a satellite communication system 400 in such conditions will be described later with reference to FIG. 11.

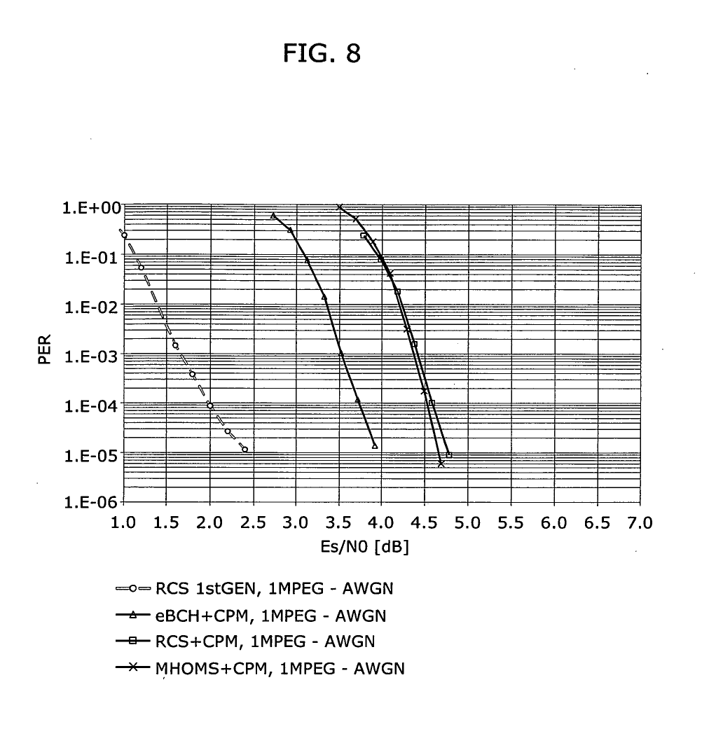

FIG. 8 shows PER performance through an AWGN channel when 1 MPEG packet size is 1504 bits and spectral efficiency is 0.75 bit/s/Hz. The result shown in FIG. 8 is similar to that shown in FIG. 7.

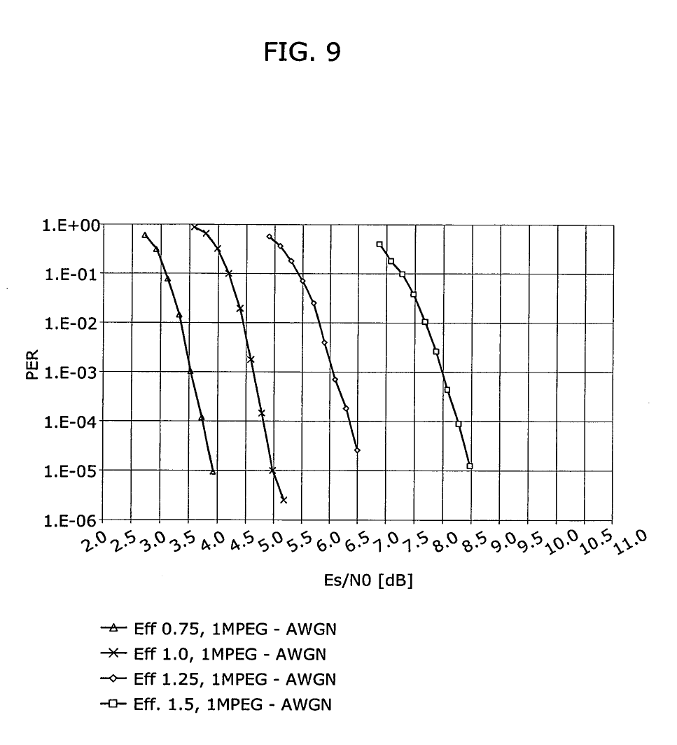

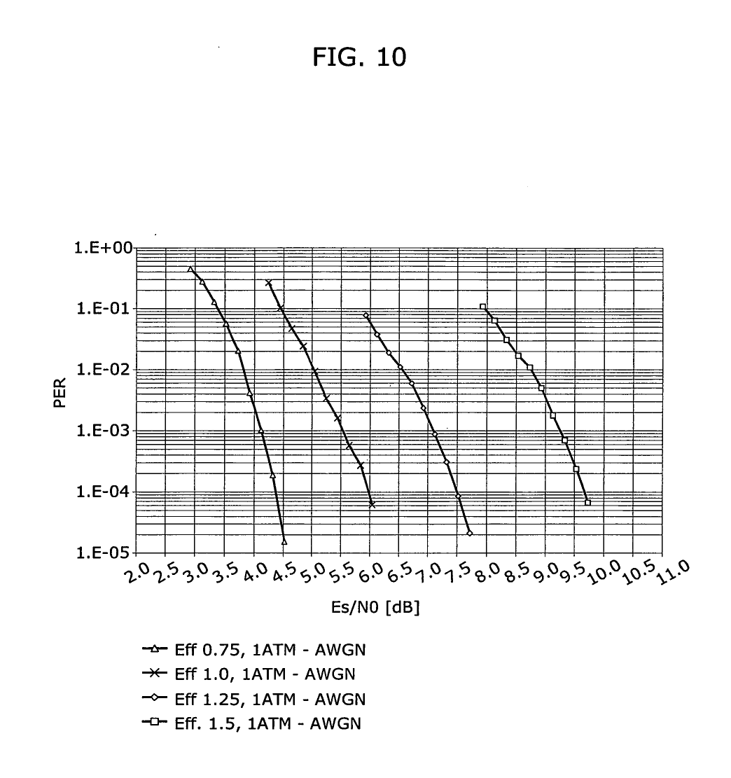

FIGS. 9 and 10 show PER performance and necessary Es/N0 of a satellite communication system 400 based on spectral efficiency described in Table 3. Specifically, FIG. 9 corresponds to a case in which 1 MPEG packet size is 1504 bits, and FIG. 10 corresponds to a case in which ATM-SAC packet size is 456 bits.

It is clear from FIGS. 9 and 10 that the lower the spectral efficiency is, the better the PER performance is, and the smaller the Es/N0 value becomes.

FIG. 11 shows a comparison between PER performance of a satellite communication system 400 in accordance with the present invention and PER performance based on a conventional DVB-RCS scheme when ATM-SAC packet size is 456 bits.

In FIG. 11, the preamble length of a conventional DVB-RCS burst frame is 48, and a burst frame in accordance with the present invention has a structure of: Nₚᵣₑ=N_{mid}=32, N_{dist}=30. FIG. 11 shows PER performance when the data rate given in Table 4 below in connection with spectral efficiency is 380 kbit/s. In other words, FIG. 11 gives PER performance of the satellite communication system 400 when spectral efficiency is 0.75 bit/s/Hz. It is clear from FIG. 11 that, in a carrier instability environment, the method for transmitting/receiving data in accordance with the present invention exhibits better PER performance than the conventional DVB-RCS scheme. In the case of the method for transmitting/receiving data in accordance with the present invention, degradation caused by frequency and phase noise is 0.2-0.4 dB, which means better performance than conventional DVB-RCS.

Table 4 below shows symbol rate and data rate values in terms of spectral efficiency. It is clear that the results are similar to that shown in FIG. 11 even in other spectral efficiencies.

TABLE 4

RCS 1st generation: 380 kBaud and equivalently 380 kbit/s (½-
QPSK);
e-BCH + CPM, Eff. 0.75: 273 kBaud and equivalently 380 kbit/s;
e-BCH + CPM, Eff. 1.0: 372 kBaud and equivalently 520 kbit/s;
e-BCH + CPM, Eff. 1.25: 458 kBaud and equivalently 640 kbit/s;
e-BCH + CPM, Eff. 1.5: 506 kBaud and equivalently 768 kbit/s;

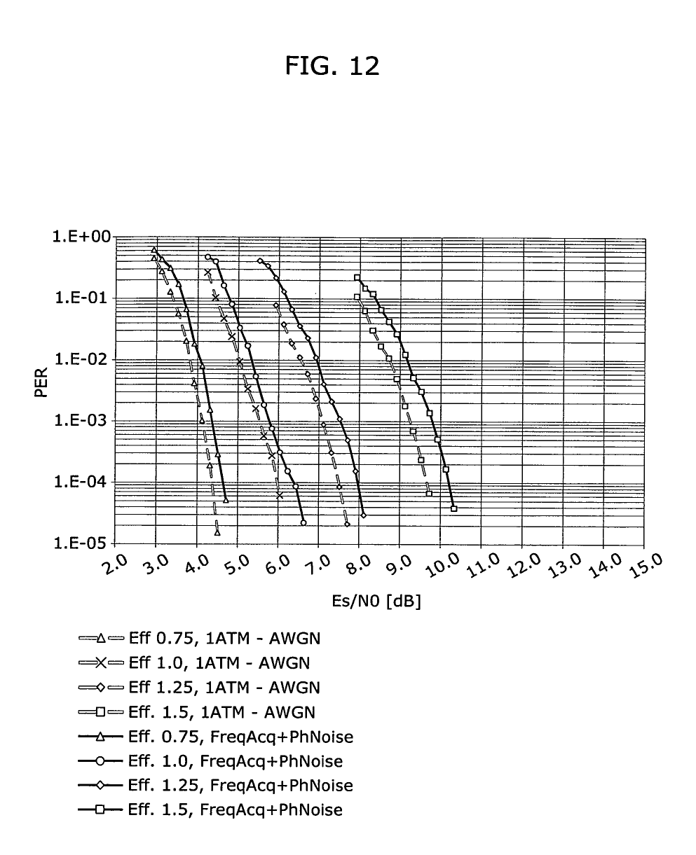

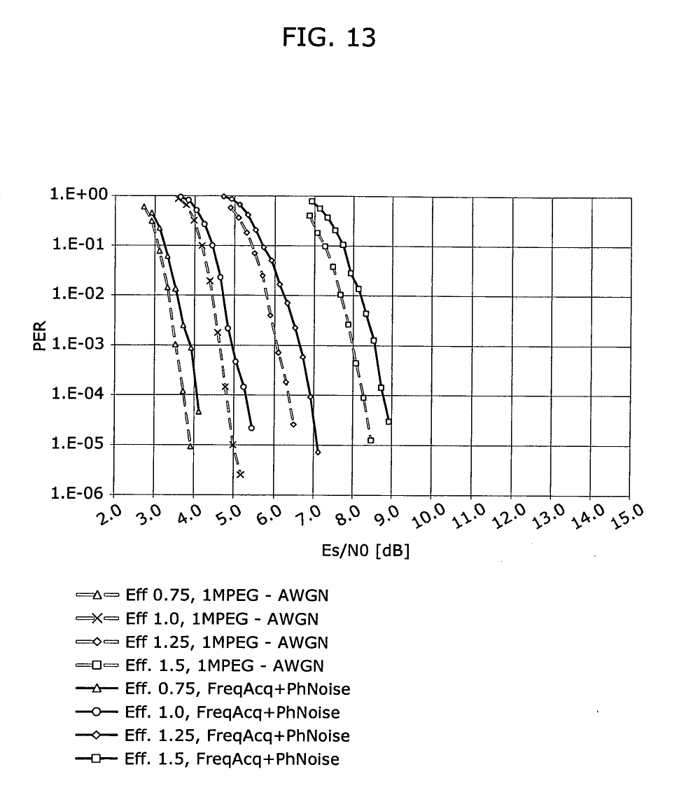

FIGS. 12 and 13 show comparisons of PER performance of a satellite communication system 400 in accordance with the present invention in different communication environments. Specifically, FIGS. 12 and 13 show comparisons of PER performance when ATM-SAC packet size is 456 bits and when 1 MPEG packet size is 1504 bits, respectively.

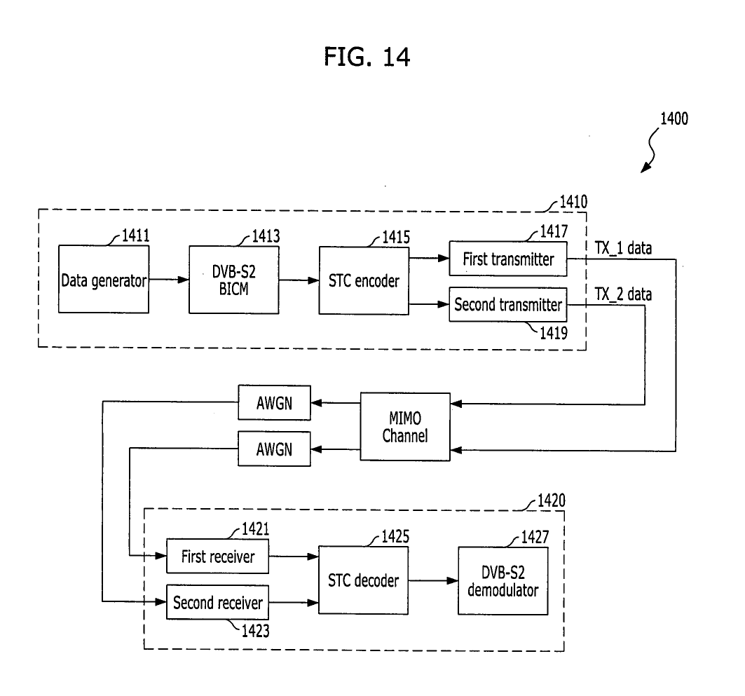

FIG. 14 illustrates a method for transmitting/receiving data using a satellite in accordance with another embodiment of the present invention. The satellite communication system 1400 shown in FIG. 14 follows DVB-S2 standards and adopts a Single Channel Per Carrier (SCPC) access scheme, according to which only one channel is allocated to a carrier for transmission during satellite communication.

The method for transmitting/receiving data in accordance with the present invention provides a method for transmitting/receiving data through a return link. The method for transmitting/receiving data in accordance with the present invention employs a Multi-Input Multi-Output (MIMO) system and a space-time code to increase the data transmission rate. In the MIMO system, different information is transmitted through each transmission antenna to increase the amount of information. Use of a space-time code gives transmitted information diversity effect and coding gain so that the reliability of the transmitted information improves. The space-time code refers to technology of coding the same data for a plurality of transmission antennas so that the reliability of transmitted data improves.

Referring to FIG. 14, the satellite communication system 1400 in accordance with the present invention includes a user terminal 1410 and a hub station 1420.

The user terminal 1410 includes a data generator 1411, a DVB-S2 Bit Interleaved Coded Modulation (BICM) 1413, a STC encoder 1415, a first transmitter 1417, and a second transmitter 1419.

The DVB-S2 BICM 1413 is configured to encode, interleave, and modulate bit data generated by the data generator 1411. Specifically, the DVB-S2 BICM 1413 encodes, interleaves, and modulates bit data according to DVB-S2 standards.

The STC encoder 1415 is configured to channel-encode data, which has been modulated by the DVB-S2 BICM 1413, using a time-space code. The first and second transmitters 1417 and 1419 are configured to transmit the channel-encoded data to the hub station. Each of the first and second transmitters 1417 and 1419 can generate a burst frame and may include an antenna based on a MIMO system. Specifically, each of the first and second transmitters 1417 and 1419 may include a polarization vertical antenna using vertical polarization and a polarization horizontal antenna using horizontal polarization.

This construction in accordance with the present invention employs a MIMO system and a space-time code so that, through frequency reuse, i.e. polarization reuse, the link throughput doubles. Signals transmitted through the same frequency undergo spatially different fading due to scatterers on the radio channel, and thus have different spatial characteristics. Therefore, the receiving side can differentiate the transmitted signals.

The STC encoder 1415 may use a golden code as the space-time code, and the golden code can be defined by Equation 22 below, wherein S₁, S₂, S₃, and S₄ refer to complex-valued information symbols, θ refers to a golden number

$$( θ = \frac{1 + \sqrt{5}}{2} \approx 1.618 ) ,$$

x₁ and x₂ refer to complex symbols transmitted from the first transmitter 1417, and x₃ and x₄ refer to complex symbols transmitted from the second transmitter 1419.

$$\begin{matrix}\begin{matrix}X = [ \begin{matrix}{x}_{1} & {x}_{2} \\ {x}_{3} & {x}_{4}\end{matrix} ] \\ = \frac{1}{\sqrt{5}} [ \begin{matrix}α ( {S}_{1} + θ {S}_{2} ) & α ( {S}_{3} + θ {S}_{4} ) \\ iσ ( α ) ( {S}_{3} + σ ( θ ) {S}_{4} ) & σ ( α ) ( {S}_{1} + σ ( θ ) {S}_{2} )\end{matrix} ]\end{matrix} \\ σ ( θ ) = 1 - θ = \frac{1 - \sqrt{5}}{2} \\ α = 1 + iσ ( θ ) \\ σ ( α ) = 1 + iθ\end{matrix} \qquad Eq . 22$$

The hub station 1420 includes a first receiver 1421, a second receiver 1423, a STC decoder 1425, and a DVB-S2 demodulator 1427.

The first and second receivers 1421 and 1423 are configured to receive data transmitted from the user terminal 1410. Specifically, data is transmitted from the user terminal 1410 to the hub station 1420 through a MIMO channel and an AWGN channel. The first receiver 1421 is configured to receive data from the first transmitter 1417, and the second receiver 1423 is configured to receive data from the second transmitter 1419.

The STC decoder 1425 is configured to decode the data, which has been received by the first and second receivers 1421 and 1423, using a space-time code. The STC decoder 1425 may use a golden code to decode the received data.

The DVB-S2 demodulator 1427 is configured to demodulate the decoded data according to DVB-S2 standards.

Meanwhile, the above-described method for transmitting/receiving data exhibits better performance in a Line-Of-Sight (LOS) environment where transmitting and receiving antennas face each other.

Those skilled in the art can understand that, although no satellite is included in the satellite communication system 1400 described with reference to FIG. 14, signals from a user terminal are transmitted to the hub station through a relay satellite in an actual satellite communication system, as has been mentioned with reference to FIG. 4.

The method for transmitting/receiving data in accordance with an embodiment of the present invention is summarized as follows.

The method for transmitting data in accordance with the present invention is as follows: The user terminal 1410 modulates encoded and interleaved bit data, and channel-encodes the modulated data using a space-time code. The user terminal 1410 transmits the encoded data to the hub station 1420 using a polarization vertical antenna and a polarization horizontal antenna.

The user terminal 1410 may use a golden code as the space-time code to perform channel encoding, and modulates bit data, which has been encoded and interleaved according to DVB-S2 standards, according to the DVB-S2 standards.

The method for receiving data in accordance with the present invention is as follows: The hub station 1420 receives data from the user terminal 1410 using a polarization vertical antenna a polarization horizontal antenna, decodes the received data using a space-time code, and demodulates the decoded data.

The hub station 1420 may use a golden code as the space-time code to perform decoding, and performs demodulation according to DVB-S2 standards.

In accordance with the exemplary embodiments of the present invention, the transmission performance in a carrier instability environment, where frequency error, phase noise, and the like occur, is better than in the case of a conventional DVB-RCS system. That is, the present invention provides better transmission performance in an inferior communication environment so that an inexpensive analog device can be used for the user terminal, for example. This consequently reduces the cost for operation and utilization of the satellite communication system. Furthermore, in accordance with the present invention, frequency is reused using a MIMO system and a space-time code in a satellite communication system based on DVB-S2 standards, thereby improving the overall data transmission rate.

The above-described methods for transmitting/receiving data using a satellite in accordance with the present invention can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. A method for transmitting data using a satellite channel, comprising:
channel-encoding bit data using an e-BCH code;
interleaving the encoded data;
modulating the interleaved data according to a CPM scheme using four symbols; and
transmitting the modulated data to a hub station.

2. The method of claim 1, wherein in said interleaving the encoded data,
S-random interleaving is performed.

3. The method of claim 1, wherein said transmitting the modulated data to a hub station comprises:
generating a burst frame using the modulated data; and
transmitting the generated burst frame to the hub station,
the burst frame comprises a preamble interval, a first data interval, a symbol interval for changing a modulation state of a receiving side into a predetermined state, a midamble interval, and a second data interval successively, and
the bit data comprises the first data and the second data.

4. The method of claim 1, wherein the four symbols are −3, −1, 1, and 3, and the four symbols are mapped onto 00, 01, 11, and 10 bits, respectively.

5. A method for receiving data using a satellite channel, comprising:
demodulating data transmitted from a user terminal according to a CPM scheme using four symbols;
deinterleaving the demodulated data; and
decoding the deinterleaved data using an e-BCH code.

6. The method of claim 5, wherein in said deinterleaving the demodulated data,
soft decision is performed with regard to the demodulated data through Log-Likelihood Ratio (LLR) deinterleaving.

7. The method of claim 5, further comprising:
performing frequency estimation for removing frequency error of the data transmitted from the user terminal.

8. The method of claim 5, wherein the method further comprises interleaving the decoded data, and
in said demodulating data transmitted from a user terminal according to a CPM scheme using four symbols,
the interleaved data is demodulated a predetermined number of times.

9. The method of claim 5, wherein the four symbols are −3, −1, 1, and 3, and the four symbols are demapped onto 00, 01, 11, and 10 bits, respectively.

10. A method for transmitting data using a satellite channel, comprising:
modulating encoded and interleaved bit data;
channel-encoding the modulated bit data using a space-time code; and
transmitting the encoded data to a hub station using a polarization vertical antenna and a polarization horizontal antenna.

11. The method of claim 10, wherein in said channel-encoding the modulated bit data using a space-time code,
channel encoding is performed using a golden code as the space-time code.

12. The method of claim 10, wherein in said modulating encoded and interleaved bit data,
bit data encoded and interleaved according to a DVB-S2 standard is modulated according to the DVB-S2 standard.

13. A method for receiving data using a satellite channel, comprising:
receiving data transmitted from a user terminal using a polarization vertical antenna and a polarization horizontal antenna;
decoding the received data using a space-time code; and
demodulating the decoded data.

14. The method of claim 13, wherein in said decoding the received data using a space-time code,
decoding is performed using a golden code as the space-time code.
